(19) United States
(12) Patent Application Publication
(10) Pub. No.: US 2025/0088998 A1
(43) Pub. Date: Mar. 13, 2025

(54) ACTIVATION OF BROADBAND NETWORK SERVICES VIA CELLULAR NETWORK USER EQUIPMENT

(71) Applicant: Apple Inc., Cupertino, CA (US)

(72) Inventors: Samy Touati, Pleasanton, CA (US); Elliot S. Briggs, Carmel, CA (US); Raj S. Chaugule, Santa Clara, CA (US); Rohan C. Malthankar, San Jose, CA (US); Vikrant R. Sarle, Santa Clara, CA (US); Sai Raj Karra, San Jose, CA (US); John Basacchi, San Diego, CA (US); Vikram B. Yerrabommanahalli, San Ramon, CA (US); Jianwei Chen, Fremont, CA (US); Eduardo de Almeida Abrantes, Los Altos, CA (US)

(21) Appl. No.: 18/826,931

(22) Filed: Sep. 6, 2024

Related U.S. Application Data
(60) Provisional application No. 63/581,584, filed on Sep. 8, 2023.

(51) Int. Cl. H04W 60/04; H04W 12/069; H04W 12/08; H04W 12/69

(52) U.S. Cl. CPC H04W 60/04; H04W 12/069; H04W 12/08; H04W 12/69

(57) ABSTRACT

Systems, methods, processors, and circuitries are provided for activation of broadband network services via cellular network user equipment (UE). In some aspects, a UE includes a memory and a processor. The processor is coupled to the memory and configured to, when executing instructions stored in the memory, cause the UE to determine, via a cellular network, an entitlement of the UE to a service of a broadband network; generate a token for the service; create a blind token based on the token; transmit, via the cellular network to a server, the blind token for signing; receive, via the cellular network from the server, a blind signature for the blind token; unblind the blind signature to yield an unblinded signature; and store the unblinded signature and the token for subsequent access to the service.

### REFERENCE TO RELATED APPLICATIONS

This application claims the benefit of U.S. Provisional Application No. 63/581,584, filed on Sep. 8, 2023, the contents of which are hereby incorporated herein by reference in their entirety.

### FIELD

This disclosure relates to techniques for activation of broadband network services via a cellular network user equipment (UE).

### BACKGROUND

Some telecommunications carriers that provide broadband network services by way of a wireless fidelity (e.g., Wi-Fi) router connected to a residential gateway (RGW) may also provide cellular communication network services (e.g., Fifth-Generation (5G) or New Radio (NR) network services). Such offerings by a carrier may be advantageous for many subscribers who regularly use one or more communication devices that access one or both types of networks. For example, given the different communication technologies involved, one network type may provide a more advantageous user experience relative to another network type under some use cases or conditions.

### BRIEF DESCRIPTION OF THE DRAWINGS

The present disclosure will be readily understood and enabled by the detailed description and accompanying figures of the drawings. Like reference numerals may designate like features and structural elements. Figures and corresponding descriptions are provided as non-limiting examples of aspects, implementations, etc., of the present disclosure, and references to “an” or “one” aspect, implementation, etc., may not necessarily refer to the same aspect, implementation, etc., and may mean at least one, one or more, etc.

FIG. 1 is a diagram of an example cellular network and associated broadband network, according to various aspects of the present disclosure.

FIGS. 2A and 2B are a message flow diagram illustrating messaging between a UE and a server over a cellular network to generate blind signatures for tokens to be used by the UE to access a broadband network service, according to various aspects of the present disclosure.

FIGS. 3A and 3B are a message flow diagram illustrating messaging among a UE, a router/RGW, and various servers over the broadband network to employ tokens to allow the UE to access a service over the broadband network, according to various aspects of the present disclosure.

FIGS. 4A and 4B are a message flow diagram illustrating messaging between a UE and a server over a cellular network to generate blind signatures for tokens to be used by an associated device to access a broadband network service, according to various aspects of the present disclosure.

FIGS. 5A and 5B are a message flow diagram illustrating messaging among an associated device, a router/RGW, and various servers over the broadband network to employ tokens to allow the device to access a service over the broadband network, according to various aspects of the present disclosure.

FIG. 6 is a flow diagram outlining an example method for a UE to generate blind signatures for a token to be used by the UE or a related device to access a broadband network service, and for the UE to employ the token to access the service, according to various aspects of the present disclosure.

FIG. 7 is a flow diagram outlining an example method for a device to employ a token to access a broadband network service, according to various aspects of the present disclosure.

FIG. 8 is a flow diagram outlining an example method for a server to process a token and associated signature to facilitate access to a broadband network service, according to various aspects of the present disclosure.

FIG. 9 is a diagram of an example of components of a device, according to various aspects of the present disclosure.

### DETAILED DESCRIPTION

The following detailed description refers to the accompanying drawings. Like reference numbers in different drawings may identify the same or similar features, elements, operations, etc. Additionally, the present disclosure is not limited to the following description as other implementations may be utilized, and structural or logical changes made, without departing from the scope of the present disclosure.

A telecommunications carrier that provides access to both a broadband network and a cellular network may desire to leverage the best characteristics of both network types for the benefit of their subscribers. For example, while the broadband network may provide a higher quality-of-service (QOS) (e.g., by way of a higher data rate and/or a reduced data latency) or other desirable service in at least some cases, authentication of the user to allow access to such a service may only be provided via the cellular network, particularly when the subscriber may access the broadband network by way of an RGW/router of another subscriber. Further, some subscriber devices (e.g., a laptop computer, a tablet computer, a virtual reality (VR) or augmented reality (AR) headset, or the like) may only be capable of accessing the broadband network, and thus may not possess the capability of determining whether the subscriber device is entitled to use such a service.

As is discussed in greater detail below, some aspects of the present disclosure may provide authentication of a user by way of a cellular network for access to one or more services provided on a broadband network. For example, in some aspects, for a user equipment (UE) that may communicate over both a cellular network and a broadband network, the UE may generate create a token for access to a service on the broadband network, create a blind token based on the token, and transmit the blind token over the cellular network to a server (e.g., an entitlement server) for signing (e.g., resulting in a blind signature) to indicate that the subscriber is entitled to the service. The UE may then unblind the signature and provide the signature and associated token to the service on the broadband network for authentication so that the UE may be enabled to use the service.

Also, in some aspects, the subscriber UE may be employed to create the blind token and obtain the associated signature over the cellular network, and then provide the associated token and unblinded signature to another subscriber device (e.g., a device that is only capable of Wi-Fi communications) to enable access to the service provided on the broadband network. Consequently, in some aspects, the user of the device may request access to the service anonymously.

Additionally, in some aspects, the ability of the UE to create blind tokens and have them signed via the cellular network for use over a broadband network may facilitate use of the service on the UE or another device of the subscriber by way of an RGW and associated router of another subscriber, thus facilitating greater geographic flexibility in providing the service to the subscriber.

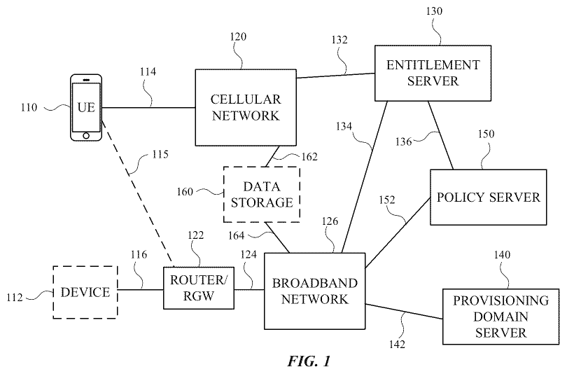

FIG. 1 is a diagram of an example cellular network 120, an associated broadband network 126, a UE 110, and various other communications devices according to various aspects of the present disclosure. Examples of UE 110 may include smartphones (e.g., handheld touchscreen mobile computing devices connectable to one or more wireless communication networks). Further, as illustrated, UE 110 may be communicatively coupled to cellular network 120 over a wireless connection 114. For example, wireless connection 114 may be provided by way of one or more radio access network (RAN) nodes (not explicitly shown in FIG. 1) in cellular network 120. In some aspects, cellular network 120 may include other various systems, including but not limited to, a core network (CN), application servers, external networks, and so on (also not explicitly shown in FIG. 1).

The systems and devices of example cellular network 120 may operate in accordance with one or more communication standards, such as Second-Generation (2G), Third-Generation (3G), Fourth-Generation (4G) (e.g., Long-Term Evolution (LTE)), and/or Fifth-Generation (5G) (e.g., New Radio (NR)) communication standards of the Third-Generation Partnership Project (3GPP). Additionally, or alternatively, one or more of the systems and devices of cellular network 120 may operate in accordance with other communication standards and protocols discussed herein, including future versions or generations of 3GPP standards (e.g., Sixth-Generation (6G) standards, Seventh-Generation (7G) standards, etc.), Institute of Electrical and Electronics Engineers (IEEE) standards (e.g., Wireless Metropolitan Area Network (WMAN), Worldwide Interoperability for Microwave Access (WiMAX), etc.), and more.

Any of the RAN nodes mentioned above can terminate an air interface protocol and can be the first point of contact for UE 110. In some implementations, any of the RAN nodes can fulfill various logical functions for a RAN, including, but not limited to, radio network controller (RNC) functions, such as radio bearer management, uplink and downlink dynamic radio resource management and data packet scheduling, and mobility management. UE 110 can be configured to communicate using orthogonal frequency-division multiplexing (OFDM) communication signals with any of the RAN nodes over a multicarrier communication channel in accordance with various communication techniques, such as, but not limited to, an orthogonal frequency-division multiple-access (OFDMA) communication technique (e.g., for downlink communications) or a single-carrier frequency-division multiple-access (SC-FDMA) communication technique (e.g., for uplink and ProSe or sidelink (SL) communications), although the scope of such implementations is not necessarily limited in this regard. The OFDM signals can include a plurality of orthogonal subcarriers.

The CN may include a plurality of network elements that are configured to offer various data and telecommunications services to customers/subscribers (e.g., the user of UE 110) who are connected to the CN via the RAN. In some implementations, the CN may include an evolved packet core (EPC), a 5G CN, and/or one or more additional or alternative types of CNs. The components of the CN may be implemented in one physical node or separate physical nodes including components to read and execute instructions from a machine-readable or computer-readable medium (e.g., a non-transitory machine-readable storage medium). In some aspects, the CN may be connected to one or more application servers, and external networks, which may include IP network interfaces.

In some aspects, UE 110 may also be coupled via a wireless router/residential gateway (RGW) 122 to a broadband network 126. In some aspects, UE 110 is coupled to router/RGW 122 by way of a wireless (e.g., Wi-Fi) connection 115, such as a connection consistent with any IEEE 702.11 protocol. In turn, router/RGW 122 may be communicatively couple to broadband network 126 by way of a communication connection 124, such as a coaxial cable connection, a wireless (e.g., microwave) communication connection, an optical communication connection, or the like.

Additionally or alternatively, a device 112 may be communicatively coupled to router/RGW 122 by way of a wireless (e.g., Wi-Fi) connection 116, such as a connection consistent with any IEEE 702.11 protocol. In turn, router/RGW 122 may provide device 112 with a communication connection 124 to broadband network 126. Device 112 may include any type of mobile or non-mobile computing devices capable of wireless communications over wireless connection 116, such as laptop computers, desktop computers, wireless handsets, virtual reality (VR) or augmented reality (AR) headsets, personal data assistants (PDAs), etc.

Also depicted in FIG. 1 are a number of servers or other components, at least one or more of which are accessible by way of cellular network 120 and/or broadband network 126. Such servers include an entitlement server 130, a provisioning domain server 140, and a policy server 150. In addition, in some aspects, a data storage 160 (e.g., a cloud storage facility, a data repository, an online database, a subscriber account database, or the like) may be included. Each of entitlement server 130, provisioning domain server 140, and policy server 150 may be a standalone server or combined with one or more additional servers.

As shown in FIG. 1, entitlement server 130 may be communicatively coupled with cellular network 120 (e.g., via connection 132), broadband network 126 (e.g., via connection 134), and policy server 150 (e.g., via connection 136). In addition, broadband network 126 may also be communicatively coupled to policy server 150 (e.g., via connection 152) and to provisioning domain server 140 (e.g., via connection 142). Data storage 160 may be communicatively coupled to both cellular network 120 (e.g., via connection 162) and broadband network 126 (e.g., via connection 164). In some aspects, one or more of entitlement server 130, provisioning domain server 140, policy server 150, and data storage 160 may be considered to be included within cellular network 120 and/or broadband network 126, but are shown separately therefrom to facilitate the discussion below.

In the description below, a user device (e.g., UE 110 and/or device 112) may access one or more services provided by broadband network 126 to which the user of the user device is entitled. Examples of such services may include, but are not limited to, quality-of-service (QOS)-related services (e.g. enhanced speed or data rate, reduced latency, and the like), parental control, etc. In some aspects, a range of levels or grades may be associated with one or more such services, where a user device may be entitled to a particular level or grade of such service. Further, one or more enumerated services may be associated with a particular user device that may benefit from the availability of the services. In some aspect, a user may be entitled to such one or more services by being a subscriber to access cellular network 120 and/or broadband network 126 (e.g., by paying for a particular level of subscription). In some aspects, such a service may be considered an advanced or enhanced feature of broadband network 126 not generally available to all users or subscribers of broadband network 126.

At least some of this access is controlled by a server (e.g., entitlement server 130) by way of one or more signed “tokens.” As employed herein, a token may be a data item that, when signed by the server, enables a user device (e.g., UE 110 and/or device 112) to access the associated service if the user associated with the user device is entitled to access that service. In some aspects, a token may be a one-use token that is consumed when the user device provides the token to validate and/or access the service. Consequently, multiple tokens may be created at a time and subsequently signed and validated as a group for future consumption as individual tokens over some period of time.

As described in greater detail below, in some aspects, entitlement server 130 may perform one or more operations associated with service access by a user device. In some aspects, entitlement server 130, in response to an enquiry from UE 110 regarding a particular service, may verify whether UE 110 or the user thereof is entitled to access that service. Also, in some aspects, entitlement server 130 may sign one or more tokens provided by UE 110 and return those tokens to UE 110. In some aspects, entitlement server 130 may receive the tokens and associated signatures from the UE 110 or device 112 and validate the signatures so that UE 110 or device 112 may access the corresponding service of broadband network 126. In some aspects, the tokens and/or associated signatures may be “blinded” (e.g., encrypted) and/or “unblinded” (e.g., decrypted). Further, such blinding, unblinding, and associated operations are described in accordance with Network Working Group Internet-Draft “draft-irtf-cfrg-rsa-blind-signatures-14”, published Jul. 10, 2023, entitled “RSA Blind Signatures”; however, other mechanisms or protocols for blinding and unblinding tokens and signatures may be employed in other aspects of the present disclosure.

In addition, in some aspects, entitlement server 130, upon validation of the signatures mentioned above, may enable UE 110 or device 112 to access the service. To that end, entitlement server 130 may inform UE 110 or device 112 of the enablement of the service, and may inform another server (e.g., policy server 150) so that the service may be provided via router/RGW 122 to UE 110 or device 112.

In some aspects, provisioning domain server 140, in response to a provisioning domain identifier from UE 110, may provide one or more services that are supported by the broadband network 126 and to which UE 110 or the user thereof may access, if entitled to do so. As used herein, a provisioning domain may be a consistent set of network configuration information that includes various services. In some aspects, provisioning domains, or “PvDs,” may facilitate simultaneous connections to multiple networks (e.g., cellular network 120 and broadband network 126). In some aspects, a PvD may be associated with a particular provisioning domain identifier (PvD ID), which, in some aspects, may be a fully qualified domain name (FQDN), such as a Uniform Resource Locator (URL). Moreover, in some aspects, the mechanism employed by provisioning domain server 140 and other devices or components described in the present disclosure may employ a mechanism for explicitly identifying a PvD via a router advertisement option, as described in Internet Engineering Task Force (IETF) Request for Comment (RFC) 8801 (“Discovering Provisioning Domain Names and Data”). Using this mechanism, router/RGW 122 may provide UE 110 or device 112 with a PvD ID in a router advertisement (RA) in response to a router solicitation, and UE 110 or device 112 may employ the returned PvD ID to request the identity of services available on broadband network 126 from provisioning domain server 140.

Also, as described in greater detail below, in some aspects, policy server 150 may receive an indication from another server (e.g., entitlement server 130) to enable a particular service at a specified port number of an identified router/RGW 122, wherein the port number is associated with an Internet Protocol (IP) address and/or random (e.g., randomized) Media Access Control (MAC) address of UE 110 or device 112 that is enabled to access the service. In turn, policy server 150 may issue a command to router/RGW 122 to enable the service for the identified port number.

In some aspects, data storage 160 may store saved tokens and associated signatures from UE 110 for subsequent retrieval and use by associated device 112 to access the service corresponding to the tokens and signatures. In some aspects, data storage 160 may be a service or other network device that stores subscriber data, possibly including device universally unique identifiers (UUIDs), device types, and other information associated with a subscriber or user account for cellular network 120 and/or broadband network 126.

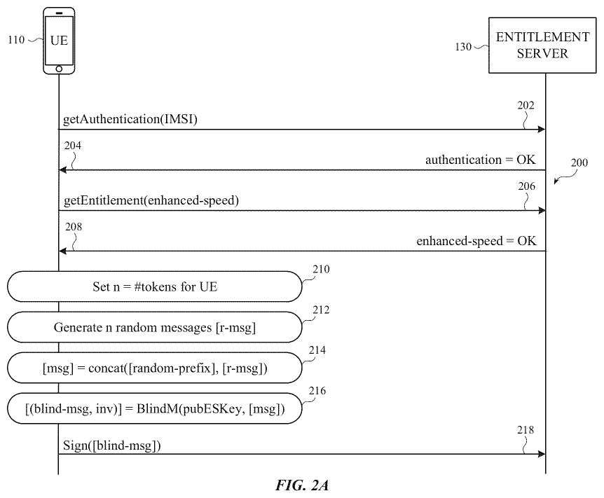

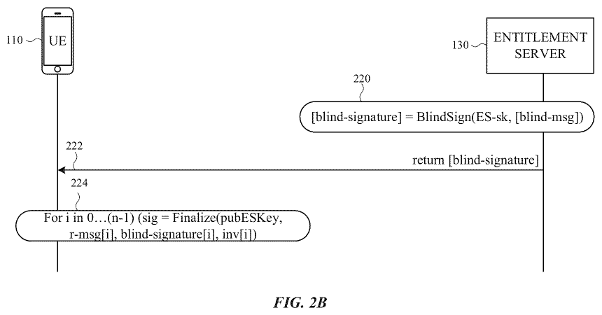

FIGS. 2A and 2B are a message flow diagram illustrating messaging 200 between UE 110 and entitlement server 130 over cellular network 120 to generate blind signatures for tokens to be used by UE 110 to access a service of broadband network 126, according to various aspects of the present disclosure. In some aspects, UE 110 may contact entitlement server 130 to be authenticated (e.g., by transmitting a getAuthentication message 202 that may carry an International Mobile Subscriber Identity (IMSI) identifying the user of UE 110). In response, entitlement server 130 may return a message 204 carrying a response or acknowledgement authenticating the identity of the user of UE 110 (e.g., “authentication=OK”).

In response to message 204, UE 110 may transmit a message 206 to entitlement server 130 requesting whether UE 110 is entitled to use a particular service of broadband network 126 (e.g., “enhanced-speed”, or an enhanced data rate). In response, entitlement server 130 may return a message 208 carrying a response or acknowledgement indicating that UE 110 is entitled to use the service (e.g., “enhanced-speed=OK”).

Once a determination is made that UE 110 is entitled to the enhanced speed service, UE 110 may generate one or more tokens for signature (e.g., by entitlement server 130) and subsequent use by UE 110 to access the service. For example, at operation 210, UE 110 may determine a number n of tokens to be created for UE 110. In some aspects, n may be a default number of tokens (e.g., ten) to be created for UE 110 (e.g., associated with the service to be used), a configured number of tokens to be created (e.g., previously received by or configured for UE 110), or the like.

Thereafter, UE 110 may create and process (e.g., in conjunction with entitlement server 130) n tokens. In some aspects, as described in greater detail below, such creation and processing may be performed according to Network Working Group Internet-Draft “draft-irtf-cfrg-rsa-blind-signatures-14”, published Jul. 10, 2023, entitled “RSA Blind Signatures”.

For example, UE 110, at operation 212, may generate n random messages (e.g., [r-msg], in which the brackets ([ ]) may indicate “a set of one or more”), each of which may be included as at least part of a token. In some aspects, each random message may be a random byte string of some predetermined length. At operation 214, UE 110 may generate n messages (e.g., [msg]=concat ([random-prefix], [r-msg]), with each message msg being employed as a separate token. In some aspects, as indicated in FIG. 2A, each message msg may include a concatenation or joining of two values: a random prefix random-prefix and an associated random message r-msg. In some aspects, the random prefix may include a random byte string of some predetermined length (e.g., 32 bytes).

At operation 216, UE 110 may then create a blinded message for each of the n messages, resulting in n blinded messages. In some aspects, UE 110 may create each blinded message by encrypting the associated message with a public encryption key of entitlement server 130. As depicted in FIG. 2A, the encryption may produce [(blind-msg, inv)]=BlindM (pubESKey, [msg]), in which BlindM is a function that encrypts each message msg with a public encryption key pubESKey of entitlement server 130 to generate each associated blinded message blind-msg. In addition, in some aspects, an associated inverse (e.g., integer) value inv may also be generated to be employed subsequently to unblind a blind signature (e.g., as described in greater detail below) received by UE 110 for its corresponding blinded message blind-msg.

UE 110 may then transmit a message 218 (e.g., a Sign message) to entitlement server 130 that carriers the n blinded messages [blind-msg] for signing. Thereafter, in FIG. 2B, in response to message 218, entitlement server 130 my perform operation 220, in which each of the n blinded messages [blind-msg] are signed, resulting in a blind signature for each blinded message. In some aspects, as depicted in FIG. 2B, operation 220 results in n blind signatures [blind-signature]=BlindSign(ES-sk, [blind-msg]), in which a BlindSign function is performed to sign each of the n blind messages [blind-msg] using an entitlement server 130 secret or private key ES-sk, resulting in the n blind signatures [blind-signature]. Entitlement server 130 may then return or transmit the n blind signatures [blind-signature] in a message 222 to UE 110.

At operation 224, UE 110 may then unblind the n received blind signatures [blind-signature] to yield a corresponding n unblinded signatures. In some aspects, as shown in FIG. 2B, each of the n blind signatures may be unblinded to produce a signature sig=Finalize(pubESKey, r-msg [i], blind-signature [i], inv [i]), in which for each value i in the range of 0 to n−1, the unblinded signature sig is generated from its corresponding blind-signature [i] using entitlement server 130 public encryption key pubESKey, the associated original random message r-msg [i], and the corresponding inverse value inv [i] (described above in conjunction with operation 216 of FIG. 2A).

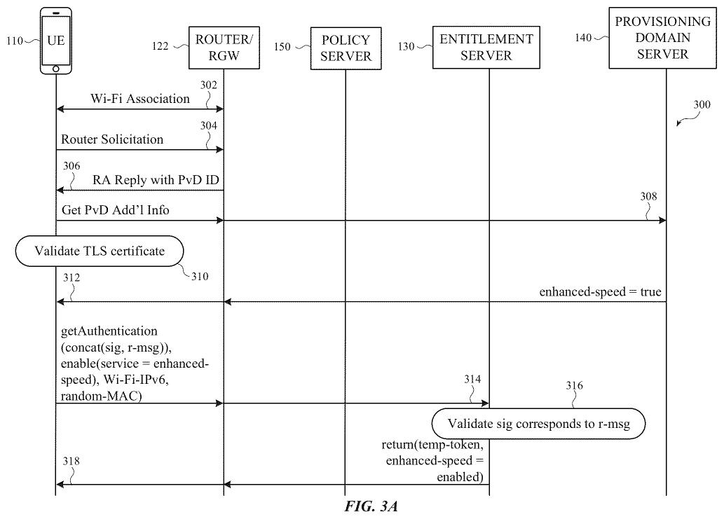

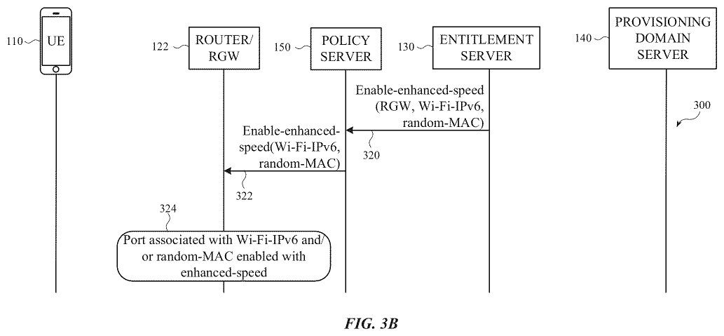

At this point, UE 110 may possess or store the previously created n random messages [r-msg] serving as tokens, each of which is associated with a corresponding unblinded signature sig. UE 110 may then employ one or more of the tokens and signatures to access the desired service (e.g., enhanced-speed) provided by broadband network 126. To that end, FIGS. 3A and 3B are a message flow diagram illustrating messaging 300 among UE 110, router/RGW 122, and various servers (e.g., entitlement server 130, provisioning domain server 140, and/or policy server 150) over broadband network 126 to employ tokens to allow UE 110 to access a service (e.g., enhanced-speed) over broadband network 126, according to various aspects of the present disclosure.

In FIG. 3A, at operation 302, UE 110, in conjunction with router/RGW 122, may create a Wi-Fi association with router/RGW 122 to facilitate subsequent communication therebetween. After the association, at message 304, UE 110 may transmit a router solicitation (e.g., to retrieve provisioning and/or configuration information associated with router/RGW 122). In response to the router solicitation, router/RGW 122 may transmit a message 306 that may include a router advertisement (RA) reply that may carry a provisioning domain identifier (PvD ID) to UE 110. In some aspects, the PvD ID may be a fully qualified domain name (FQDN) (e.g., a URL) that identifies the particular PvD that applies to UE 110 for broadband network 126. Also, in some aspects, UE 110 may compare the received PvD ID with one that is defined in a carrier bundle previously provided to UE 110 in conjunction with use of cellular network 120 such that if the two PvD IDs are not equal, UE 110 may discontinue further processing shown in FIGS. 3A and 3B.

In some aspects, if the two PvD IDs are equal, UE 110 may then employ the PvD ID to receive additional information (e.g., services of broadband network 126 available to UE 110). For example, UE 110 may transmit a message 308 via router/RGW 122 to provisioning domain server 140 that requests additional information associated with the PvD ID. In addition, after transmitting message 308, UE 110 may perform operation 310 to validate a Transport Layer Security (TLS) certificate received from provisioning domain server 140 to certify the identity of provisioning domain server 140. Also, in response to message 308, provisioning domain server 140 may transmit a message 312 via router/RGW 122 to UE 110 that may indicate one or more services that are available on broadband network 126 by way of router/RGW 122. In this example, provisioning domain server 140 may indicate that the enhanced speed service is available (e.g., enhanced-speed=true). If, instead, message 312 indicates that the requested service is not available, UE 110 may not continue with further processing described below.

In response to receiving message 312 indicating the desired service is available, UE 110 may transmit a message 314 via router/RGW 122 to entitlement server 130 to provide a token and associated unblinded signature for validation to access the desired service. In some aspects, message 314 may be a message seeking authentication that includes one of the tokens (e.g., random message r-msg), the associated unblinded signature (e.g., sig), and communication path for UE 110, such as its Wi-Fi-IPv6 address for broadband network 126. In some aspects, the unblinded signature and the token may be concatenated (e.g., concat (sig, r-msg), as indicated in FIG. 3A). In some aspects, UE 110, in message 314, may additionally or alternatively provide a random (e.g., randomized) Media Access Control (MAC) address associated with UE 110. In some aspects, UE 110 may create the random MAC address for security purposes when connecting to router/RGW 122. In some aspects, UE 110 may provide its Wi-Fi-IPv6 address to entitlement server 130 in message 206 of FIG. 2A (described above) in lieu of, or in addition to, message 314.

In response to receiving message 314, entitlement server 130 may perform operation 316 to validate that the received unblinded signature (e.g., sig) corresponds to the received token (e.g., r-msg). In some aspects, entitlement server 130 may validate the unblinded signature by way of the entitlement server 130 private key mentioned above. In some aspects, this validation that leverages the blind signing process performed separately over cellular network 120 may thus preserve the privacy of the user at the time and location at which the service is provided (e.g., because the identity of the user may not be discerned due to the use of a blind token and associated blinded signature employed over cellular network 120 and the separate use of an original token and associated signature in broadband network 126). In some aspects, such anonymity may be useful, particularly if UE 110 is utilizing a router/RGW 122 that is not typically used by or associated with the subscriber.

In response to validating that the received signature corresponds to the received token, entitlement server 130 may return or transmit via router/RGW 122 to UE 110 a message 318 indicating that the desired service is enabled for UE 110 (e.g., enhanced-speed=enabled). Further, in some aspects, message 318 may also include a temporary token (e.g., temp-token, as shown in FIG. 3A). In some aspects, the temporary token may replace the token associated with the validated signature, as the associated token may have been consumed as a result of the validation. Consequently, UE 110 may employ the temporary token to employ the desired service on broadband network 126.

Also in response to validating the unblinded signature, entitlement server 130 may transmit a message 320 (shown in FIG. 3B) to policy server 150 that enables the desired service (e.g., enhanced-speed). In some aspects, message 320 may carry a command (e.g., Enable-enhanced-speed) that indicates the router/RGW 122 through which the service is to be provided, as well as the Wi-Fi-IPv6 address and/or random MAC address associated with UE 110. In turn, policy server 150 may transmit a message 322 to router/RGW 122 carrying an associated command (e.g., Enable-enhanced-speed) that indicates the Wi-Fi-IPv6 address and/or random MAC address associated with UE 110. In response to receiving message 322, router/RGW 122 may perform operation 324 to enable the port number associated with the received Wi-Fi-IPv6 address and/or random MAC address for the desired service.

In some aspects, communications and operations from message 314 of FIG. 3A through operation 324 of FIG. 3B may be repeated using another of the tokens and associated signatures obtained by UE 110 during messaging 200 of FIGS. 2A and 2B until such tokens are consumed. Further, UE 110 may generate additional tokens and associated signatures using messaging 200.

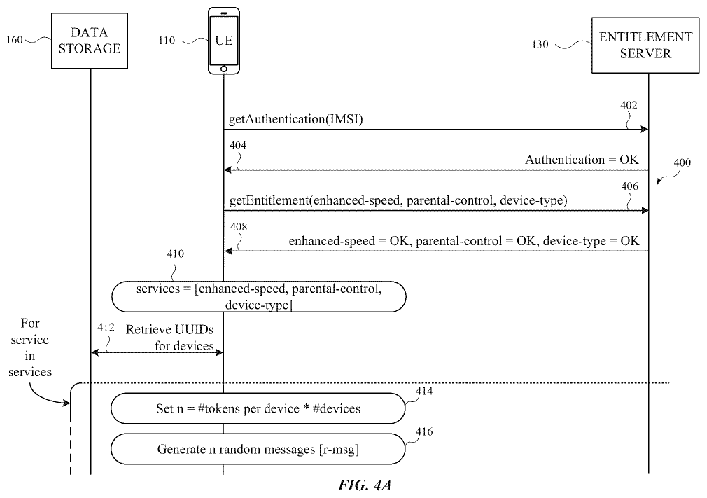

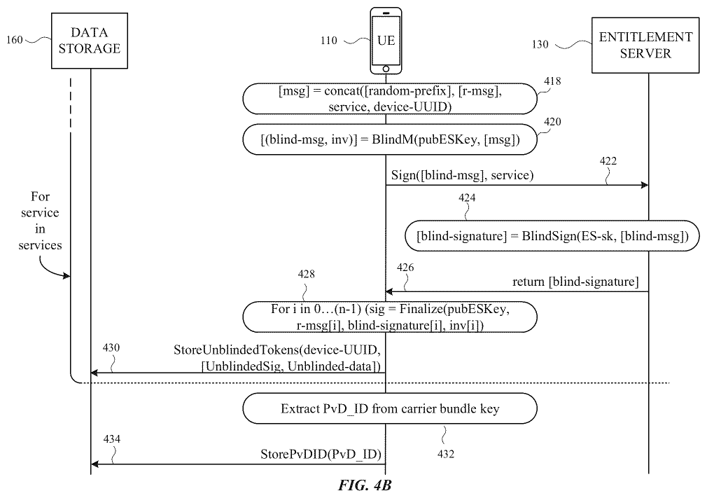

As explained above, FIGS. 2A, 2B, 3A, and 3B describe UE 110 employing the tokens and associated signatures that UE 110 was involved in creating to access a single service. In other aspects, more than one such service may be accessed by UE 110. In yet other aspects, other devices (e.g., device 112 of FIG. 1) associated with or used by a subscriber corresponding to UE 110 may access one or more such services. For example, FIGS. 4A and 4B are a message flow diagram illustrating messaging between UE 110 and a server (e.g., entitlement server 130) over cellular network 120 to generate blind signatures for tokens to be used by an associated device (e.g., device 112) to access multiple services of broadband network 126, according to various aspects of the present disclosure.

In some aspects, UE 110 may contact entitlement server 130 to be authenticated (e.g., by transmitting a getAuthentication message 402 that may carry an IMSI identifying the user of UE 110). In response, entitlement server 130 may return a message 404 carrying a response or acknowledgement authenticating the identity of the user of UE 110 (e.g., “authentication=OK”).

In response to message 404, UE 110 may transmit a message 406 to entitlement server 130 requesting whether UE 110 is entitled to use a plurality of services of broadband network 126 (e.g., “enhanced-speed”, or an enhanced data rate; “parental-control”; and “device-type, where one or more particular services are associated with a particular device type). In response, entitlement server 130 may return a message 408 carrying a response or acknowledgement indicating which of the requested services that UE 110 is entitled to use. In the example of FIG. 4A, UE 110 is entitled to all requested services (e.g., “enhanced-speed=OK, parental-control=OK, device-type=OK”).

Once a determination is made that UE 110 is entitled to one or more of the requested services, UE 110 may perform operation 410, in which the entitled services may be enumerated as a set (e.g., services=[enhanced-speed, parental-control, device-type], as shown in FIG. 4A) for further use in generating tokens, as described in greater detail below.

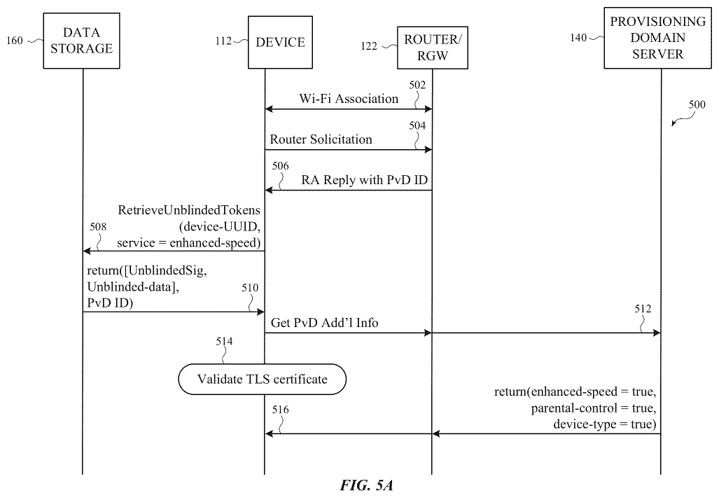

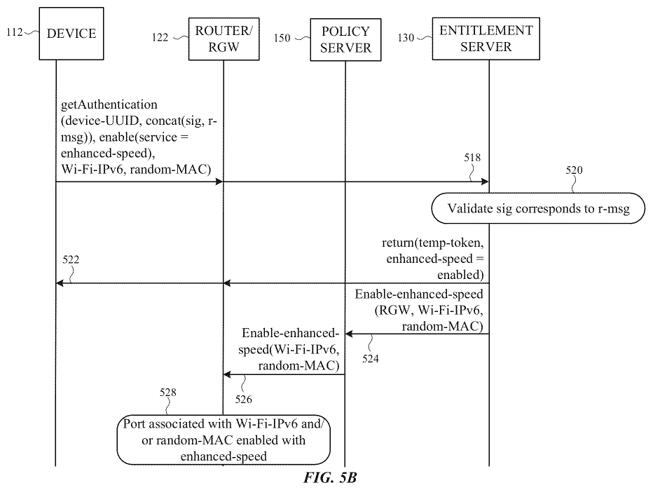

Also, UE 110 may retrieve from data storage 160 via message(s) 412, an identifier (e.g., a universally unique identifier (UUID)) for each of a number of devices (e.g., device 112) associated with UE 110. In some aspects, data storage 160 may be an account database, account server, or another data storage device accessible via cellular network 120 and broadband network 126. In some aspects, data storage 160 may be located internal to UE 110 for subsequent access by device 112 (e.g., via a local communications interface, such as Bluetooth, Near-Field Communication (NFC), or the like). In either case, device 112 may subsequently access the data stored in data storage 160 for later use in accessing one or more of the requested services, as described below with respect to FIGS. 5A and 5B.

Thereafter, UE 110 may perform a set of messaging and operations (e.g., operation 414 of FIG. 4A through message 430 of FIG. 4B) for each requested service in the set of services to create one or more tokens and associated signatures to facilitate access to one or more of the services by device 112. For example, UE 110 may generate one or more tokens for signature (e.g., by entitlement server 130) and subsequent use by device 112 to access the service. For example, at operation 414, UE 110 may determine a number n of tokens to be created per device 112, multiplied by the number of devices 112 that may access the service. In some aspects, n may be a default or previously configured number of tokens (e.g., ten) to be created per device 112 (e.g., associated with the service to be used), multiplied by the number of devices 112.

Thereafter, UE 110 may create and process (e.g., in conjunction with entitlement server 130) n tokens to be shared by the devices 112 to access the service. In some aspects, as indicated above, such creation and processing may be performed according to Network Working Group Internet-Draft “draft-irtf-cfrg-rsa-blind-signatures-14”, published Jul. 10, 2023, entitled “RSA Blind Signatures”.

For example, UE 110, at operation 416, may generate n random messages (e.g., [r-msg]), each of which may be included as at least part of a token. In some aspects, each random message may be a random byte string of some predetermined length. At operation 418 of FIG. 4B, UE 110 may generate n messages, with each message being employed as a separate token. In some aspects, each message msg may include a concatenation or joining of two or more values, including a random prefix random-prefix and an associated random message r-msg. In some aspects, the random prefix may include a random byte string of some predetermined length (e.g., 32 bytes). In addition, as shown in FIG. 4B, also concatenated to the message msg may be a service indicator service (e.g., an indication of the particular service to be provided) and/or a device UUID device-UUID for device 112. In some examples, the service indicator may be employed to aid in identifying which tokens are associated with which service, while the device UUID may be used by broadband network 126 to possibly limit the number of devices that are accessing a particular service during a particular period of time.

At operation 420, UE 110 may then create a blinded message for each of the n messages, resulting in n blinded messages. In some aspects, UE 110 may create each blinded message by encrypting the associated message with a public encryption key of entitlement server 130. As depicted in FIG. 4B, the encryption may produce [(blind-msg, inv)]=BlindM (pubESKey, [msg]), in which BlindM is a function that encrypts each message msg with a public encryption key pubESKey of entitlement server 130 to generate each associated blinded message blind-msg. In addition, in some aspects, an associated inverse (e.g., integer) value inv may also be generated to be employed subsequently to unblind a blind signature (e.g., as described in greater detail below) received by UE 110 for its corresponding blinded message blind-msg.

At message 422, UE 110 may then transmit to entitlement server 130 (e.g., by way of a Sign message) the n blinded messages [blind-msg] and the associated service service for signing. Thereafter, in response to message 422, entitlement server 130 my perform operation 424, in which each of the n blinded messages [blind-msg] are signed, resulting in a blind signature for each blinded message. In some aspects, operation 424 results in n blind signatures [blind-signature]=BlindSign (ES-sk, [blind-msg]), in which a BlindSign function is performed to sign each of the n blind messages [blind-msg] using an entitlement server 130 secret or private key ES-sk, resulting in the n blind signatures [blind-signature]. Entitlement server 130 may then return or transmit the n blind signatures [blind-signature] in a message 426 to UE 110.

At operation 428, UE 110 may then unblind the n received blind signatures [blind-signature] to yield a corresponding n unblinded signatures. In some aspects, as shown in FIG. 4B, each of the n blind signatures may be unblinded to produce a signature sig=Finalize (pubESKey, r-msg [i], blind-signature [i], inv [i]), in which for each value i in the range of 0 to n−1, the unblinded signature sig is generated from its corresponding blind-signature [i] using entitlement server 130 public encryption key pubESKey, the associated original random message r-msg [i], and the corresponding inverse value inv [i] (described above in conjunction with operation 420).

UE 110 may then store the unblinded signatures and associated unblinded tokens (and possibly other data as unblinded data), along with the corresponding device UUID device-UUID, at data storage 160 via a message 430 (e.g., StoreUnblindedTokens (device-UUID, [UnblindedSig, Unblinded-data]). In some aspects, unblinded signatures and tokens may be stored in a local data storage in UE 110.

Messages and operations (e.g., from operation 414 of FIG. 4A through message 430 of FIG. 4B) may be repeated for each service in the set of services. After all the associated tokens and unblinded signatures are stored, UE 110 may perform operation 432 to extract the PvD ID (e.g., from a carrier bundle key associated with cellular network 120) and transmit message 434 carrying the PvD ID to store in data storage 160 (e.g., using a message StorePvDID(PvD_ID)). As indicated above, data storage 160 may be internal to UE 110 or a component (e.g., a storage device, an account database, or the like) via broadband network 126.

At this point, UE 110 may possess or store the previously created n random messages [r-msg] serving as tokens for each device 112 and entitled service, and each of the tokens may be associated with a corresponding unblinded signature sig. Device 112 may then employ one or more of the tokens and signatures that is associated with device 112 and a desired service to access that service (e.g., enhanced-speed, parental-control, and/or device-type) provided by broadband network 126. To that end, FIGS. 5A and 5B are a message flow diagram illustrating messaging 500 among device 112, router/RGW 122, and various servers (e.g., entitlement server 130, provisioning domain server 140, and/or policy server 150) over broadband network 126 to employ tokens to allow device 112 to access a service over broadband network 126, according to various aspects of the present disclosure.

In FIG. 5A, at operation 502, device 112, in conjunction with router/RGW 122, may create a Wi-Fi association with router/RGW 122 to facilitate subsequent communication therebetween. After the association, at message 504, device 112 may transmit a router solicitation (e.g., to retrieve provisioning and/or configuration information associated with router/RGW 122). In response to the router solicitation, router/RGW 122 may transmit a message 506 that may include a router advertisement (RA) reply that may carry a PvD ID to device 112. In some aspects, the PvD ID may be a fully qualified domain name (FQDN) (e.g., a URL) that identifies the particular PvD that applies to device 112 for broadband network 126. Also, in some aspects, device 112 may compare the received PvD ID with one that is defined in a carrier bundle previously associated with UE 110 such that if the two PvD IDs are not equal, device 112 may discontinue further processing shown in FIGS. 5A and 5B.

Device 112 may then employ its device UUID device-UUID as well as a particular desired service (e.g., service=enhanced-speed) (e.g., by transmitting a message 508 to data storage 160) to retrieve tokens and associated unblinded signatures corresponding to the service. In some aspects, message 508 may include a command RetrieveUnblindedTokens(device-UUID, service=enhanced speed). In response, data storage 160 may transmit or return, to device 112, message 510 that carries the requested tokens and unblinded signatures (e.g., [UnblindedSig, Unblinded-data]), and possibly a PvD ID associated with UE 110. In some aspects, instead of retrieving the tokens and associated unblinded signatures from data storage 160, device 112 may retrieve those items from UE 110 (e.g., by way of a local communication connection, such as Bluetooth, Near-Field Communication (NFC), or the like). In some aspects, device 112 may compare the PvD ID received from data storage 160 with the PvD ID received from router/RGW 122 in message 506 such that if the two PvD IDs are not equal, device 112 may discontinue further processing shown in FIGS. 5A and 5B.

In some aspects, if the two PvD IDs are equal, device 112 may then employ the PvD ID to receive additional information (e.g., services of broadband network 126 available to device 112). For example, device 112 may transmit a message 512 via router/RGW 122 to provisioning domain server 140 that requests additional information associated with the PvD ID. In addition, after transmitting message 512, device 112 may perform operation 514 to validate a TLS certificate received from provisioning domain server 140 to certify the identity of provisioning domain server 140. Also, in response to message 512, provisioning domain server 140 may transmit a message 516 via router/RGW 122 to device 112 that may indicate one or more services that are available on broadband network 126 by way of router/RGW 122. In this example, provisioning domain server 140 may indicate that the enhanced speed, parental control, and device type services are available (e.g., enhanced-speed=true, parental-control=true, device-type=true). If, instead, message 516 indicates that none of the desired services are available, device 112 may not continue with further processing.

Continuing with FIG. 5B, in response to receiving message 516 indicating at least one of the desired services (e.g., enhanced-speed) is available, device 112 may transmit a message 518 via router/RGW 122 to entitlement server 130 to provide a token and associated unblinded signature for validation to access the desired service. In some aspects, message 518 may be a message seeking authentication that includes one of the tokens (e.g., random message r-msg), the associated unblinded signature (e.g., sig), and connection information for device 112, such as its Wi-Fi-IPv6 address for broadband network 126. In some aspects, device 112, in message 518, may additionally or alternatively provide a random (e.g., randomized) MAC address associated with device 112. In some aspects, device 112 may create the random MAC address for security purposes when connecting to router/RGW 122. In some aspects, the unblinded signature and the token may be concatenated (e.g., concat (sig, r-msg), as indicated in FIG. 5B). Also, in some aspects, UE 110, in message 518, may also provide an indicate of the service to be enabled (e.g., enable (service=enhanced-speed) and/or a device UUID (e.g., device-UUID) for device 112. In some aspects, UE 110 may provide its Wi-Fi-IPv6 address to entitlement server 130 in message 406 of FIG. 4A (described above) in lieu of, or in addition to, message 518.

In response to receiving message 518, entitlement server 130 may perform operation 520 to validate that the received unblinded signature (e.g., sig) corresponds to the received token (e.g., r-msg). In some aspects, entitlement server 130 may validate the unblinded signature by way of the entitlement server 130 private key mentioned above. In some aspects, this validation that leverages the blind signing process performed separately over cellular network 120 may thus preserve the privacy of the user at the time and location at which the service is provided, as described above (e.g., because the user identity may not be discerned due to the use of a blind token and associated blinded signature employed over cellular network 120 and the separate use of an original token and associated signature in broadband network 126). In some aspects, such anonymity may be useful, particularly if device 112 is utilizing a router/RGW 122 that is not typically used by or associated with the subscriber.

In response to validating that the received signature corresponds to the received token, entitlement server 130 may return or transmit via router/RGW 122 to device 112 a message 522 indicating that the desired service is enabled for device 112 (e.g., enhanced-speed=enabled). Further, in some aspects, message 522 may also include a temporary token (e.g., temp-token, as shown in FIG. 5B). In some aspects, the temporary token may replace the token associated with the validated signature, as the associated token may have been consumed as a result of the validation. Consequently, device 112 may employ the temporary token to employ the desired service on broadband network 126.

Also in response to validating the unblinded signature, entitlement server 130 may transmit a message 524 to policy server 150 that enables the desired service (e.g., enhanced-speed). In some aspects, message 524 may carry a command (e.g., Enable-enhanced-speed) that indicates the router/RGW 122 through which the service is to be provided, as well as the Wi-Fi-IPv6 address and/or random-MAC address associated with device 112. In turn, policy server 150 may transmit a message 526 to router/RGW 122 carrying an associated command (e.g., Enable-enhanced-speed) that indicates the Wi-Fi-IPv6 address and/or random MAC address associated with device 112. In response to receiving message 526, router/RGW 122 may perform operation 528 to enable the port number associated with the received Wi-Fi-IPv6 address and/or random MAC address for the desired service.

In some aspects, communications and operations from message 518 through operation 528 of FIG. 5B may be repeated using another of the tokens and associated signatures obtained by UE 110 during messaging 400 of FIGS. 4A and 4B until such tokens are consumed. Further, UE 110 may generate additional tokens and associated signatures using messaging 400 for use by device 112.

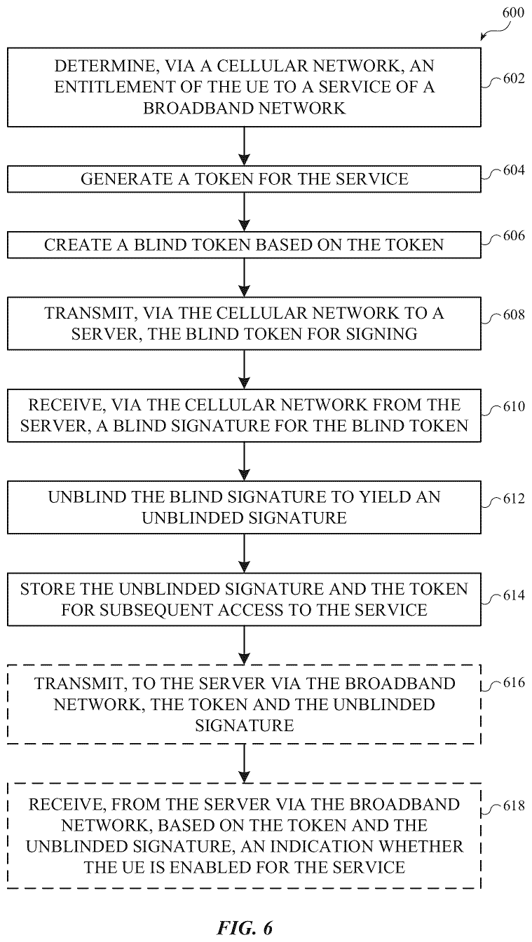

FIG. 6 is a flow diagram outlining an example method 600 for a UE (e.g., UE 110 of FIG. 1) to generate blind signatures for a token to be used by the UE or a related device (e.g., device 112 of FIG. 1) to access a service of a broadband network (e.g., broadband network 126 of FIG. 1), and for the UE to employ the token to access the service, according to various aspects of the present disclosure.

In method 600, at operation 602, the UE may determine, via a cellular network (e.g., cellular network 120 of FIG. 1), an entitlement of the UE to a service of the broadband network. In some aspects, such a service may be a QoS-related service (e.g., an enhanced speed (or data rate), a reduced latency, or the like) or a non-QoS related service (e.g., a parental control service to block or monitor certain content on the UE or an associated device). Also, in some aspects, such a service may be one or more bundled services configured for specific types or models of device (e.g., a particular type of VR headset, a particular gaming device, etc.). An example of the UE determining the entitlement is discussed above in conjunction with messages 206 and 208 of FIG. 2A and messages 406 and 408 of FIG. 4A.

At operation 604, the UE may generate a token for the service. In some aspects, the UE may generate a plurality of tokens to provide access to the service by the UE or related device. An example of the UE generating at least one token is discussed above in relation to operations 210, 212, and 214 of FIG. 2A, and in connection with operations 414 and 416 of FIG. 4A and operation 418 of FIG. 4B.

At operation 606, the UE may create a blind token based on the token. In some aspects, creating the blind token may include encrypting the token using a public encryption key of a server (e.g., entitlement server 130). An example of the UE creating the blind token is described above in relation to operation 216 of FIG. 2A and operation 420 of FIG. 4B.

At operation 608, the UE may transmit, via the cellular network to the server, the blind token for signing. An example of the UE transmitting the blind token is discussed above in connection with message 218 of FIG. 2A and message 422 of FIG. 4B.

At operation 610, the UE may receive, via the cellular network from the server, a blind signature for the blind token. An example of the UE receiving the blind signature is described above in conjunction with message 222 of FIG. 2B and message 426 of FIG. 4B.

At operation 612, the UE may unblind the blind signature to yield an unblinded signature. In some aspects, the UE may unblind each blind signature for each of one or more tokens using the public encryption key of the server and an inverse value generated during the blinding of the token at operation 606 of FIG. 6. An example of the UE unblinding the blind signature is discussed above in connection with operation 224 of FIG. 2B and operation 428 of FIG. 4B.

At operation 614, the UE may store the unblinded signature and the token for subsequent access to the service. In some aspects, the UE may store the unblinded signature and associated token either locally or in a data storage (e.g., data storage 160 of FIG. 1) accessible by the cellular network and/or the broadband network. An example of the UE storing the unblinded signature and associated token in the data storage is described above in conjunction with message 430 of FIG. 4B.

In some aspects, the UE and/or the associated device may employ the stored unblinded signature and associated token to access the desired service of the broadband network. With respect to the UE, at operation 616 of FIG. 6, the UE may transmit, to the server via the broadband network, the token and the unblinded signature. An example of the UE transmitting the token and the unblinded signature is discussed above in related to message 314 of FIG. 3A.

At operation 618, the UE may receive, from the server via the broadband network, based on the token and the unblinded signature, an indication whether the UE is enabled for the service. In some aspects, the UE may also receive a temporary token to facilitate access to the service by the UE. An example of the UE receiving the indication is described above in conjunction with message 318 of FIG. 3A.

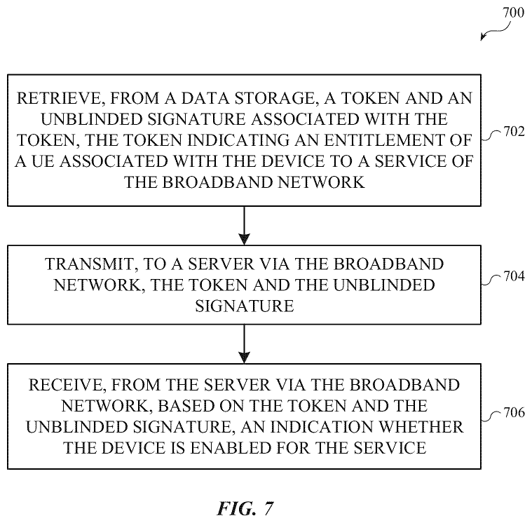

As indicated above, the stored token and related unblinded signature may instead be accessed by a device (e.g., device 112) associated with the UE to access the service provided by the broadband network. For example, FIG. 7 is a flow diagram outlining an example method 700 for the device to employ a token to access a service of a broadband network (e.g., broadband network 126), according to various aspects of the present disclosure.

In the method 700, at operation 702, the device may retrieve, from a data storage, a token and an unblinded signature associated with the token, where the token indicates an entitlement of the UE associated with the device to a service of the broadband network. In some aspects, the data storage may be a data storage (e.g., data storage 160) separate from the UE, such as a cloud storage facility, an online database, or the like. In some aspects, the data storage may be internal to the UE, where the device accesses the UE to retrieve the token and the unblinded signature. An example of the device retrieving the token and the associated unblinded signature is discussed above in connection with messages 508 and 510 of FIG. 5A.

At operation 704, the device may transmit, to a server (e.g., entitlement server 130 of FIG. 1) via the broadband network, the token and the unblinded signature. In some aspects, the device may also transmit an address or other communication path of the device to the server. An example of the device transmitting the token and the unblinded signature is described above in conjunction with message 518 of FIG. 5B.

At operation 706, the device may receive, from the server via the broadband network, based on the token and the unblinded signature, an indication whether the device is enabled for the service. In some aspects, the device may also receive a temporary token to facilitate access to the service by the device. An example of the device receiving the indication is described above in conjunction with message 522 of FIG. 5B.

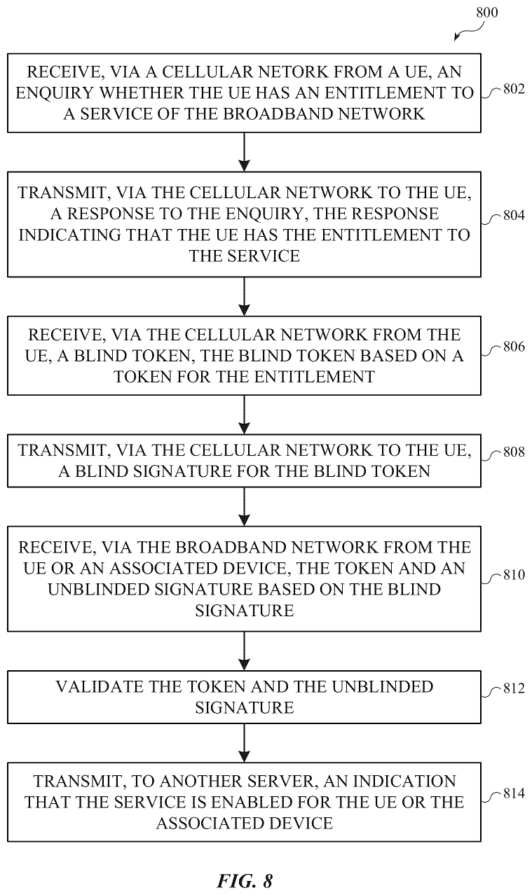

FIG. 8 is a flow diagram outlining an example method 800 for a server (e.g., entitlement server 130) to process a token and associated signature to facilitate access to a service of a broadband network (e.g., broadband network 126 of FIG. 1), according to various aspects of the present disclosure.

In the method 800, at operation 802, the server may receive, via a cellular network (e.g., cellular network 120 of FIG. 1) from a UE (e.g., UE 110 of FIG. 1), an enquiry whether the UE has an entitlement to a service of the broadband network. An example of the server receiving the enquiry is discussed above in conjunction with message 206 of FIG. 2A and message 406 of FIG. 4A.

At operation 804, the server may transmit, via the cellular network to the UE, a response to the enquiry, the response indicating that the UE has the entitlement to the service. An example of the server transmitting the response to the enquiry is described above in connection with message 208 of FIG. 2A and message 408 of FIG. 4A.

At operation 806, the server may receive, via the cellular network from the UE, a blind token that is based on a token for the entitlement. In some aspects, the blind token is an encryption of the token for the entitlement based on a public encryption key of the server. An example of the server receiving the blind token is discussed above in connection with message 218 of FIG. 2A and message 422 of FIG. 4B.

At operation 808, the server may transmit, via the cellular network to the UE, a blind signature for the blind token. In some aspects, the server may create the blind signature by processing the blind token using a private encryption key of the server. An example of the server transmitting the blind signature is described above in conjunction with message 222 of FIG. 2B and message 426 of FIG. 4B.

At operation 810, the server may receive, via the broadband network from the UE or an associated device (e.g., device 112 of FIG. 1), the token and an unblinded signature based on the blind signature. An example of the server receiving the token and the unblinded signature from the UE is discussed above in connection with message 314 of FIG. 3A, and an example of the server receiving the token and the unblinded signature from the device is described above in connection with message 518 of FIG. 5B.

At operation 812, the server may validate the token and the unblinded signature. In some aspects, the server may process the unblinded signature using a private encryption key of the server. An example of the server validating the token and the unblinded signature is discussed above in relation to operation 316 of FIG. 3A and operation 520 of FIG. 5B.

At operation 814, the server may transmit, to another server (e.g., a policy server 150 of FIG. 1), an indication that the server is enabled for the UE or the associated device. An example of the server transmitting the indication regarding enablement of the server is described above in conjunction with message 320 of FIG. 3B and message 524 of FIG. 5B.

As can be seen from the foregoing discussion, aspects of the present disclosure provide a mechanism by which a UE, using a cellular network, may determine, by way of a server (e.g., an entitlement server), one or more services of a broadband network to which the UE is entitled. The UE may also communicate with the server to create blind tokens and associated blind signatures in a manner that, in some aspects, may preserve some level of anonymity for the user when subsequently using the broadband network to access the service. Thereafter, the UE or an associated device (e.g., a laptop computer, a tablet computer, a gaming device, a VR headset, or the like that may not possess the capability to communicate via the cellular network) may communicate with the server over the broadband network to validate the token and associated signature to facilitate access to the service by the UE or device. In some aspects, the UE device may be enabled to access the service via a router/RGW that is not a router/RGW typically employed by the UE or device to access the broadband network. Such capability may be useful in cases in which a communications carrier provides both the cellular network and the broadband network, thus potentially providing a subscriber of the carrier with enhanced services for one or more devices of the subscriber by way of the broadband network in a variety of geographic locations.

Above are several flow diagrams outlining example methods and exchanges of messages. In this description and the appended claims, use of the term “determine” with reference to some entity (e.g., parameter, variable, and so on) in describing a method step or function is to be construed broadly. For example, “determine” is to be construed to encompass, for example, receiving and parsing a communication that encodes the entity or a value of an entity. “Determine” should be construed to encompass accessing and reading memory (e.g., lookup table, register, device memory, remote memory, and so on) that stores the entity or value for the entity. “Determine” should be construed to encompass computing or deriving the entity or value of the entity based on other quantities or entities. “Determine” should be construed to encompass any manner of deducing or identifying an entity or value of the entity.

As used herein, the term “identify”, when used with reference to some entity or value of an entity, is to be construed broadly as encompassing any manner of determining the entity or value of the entity. For example, the term “identify” is to be construed to encompass, for example, receiving and parsing a communication that encodes the entity or a value of the entity. The term “identify” should be construed to encompass accessing and reading memory (e.g., device queue, lookup table, register, device memory, remote memory, and so on) that stores the entity or value for the entity.

As used herein, the term “encode”, when used with reference to some entity or value of an entity, is to be construed broadly as encompassing any manner or technique for generating a data sequence or signal that communicates the entity to another component.

As used herein, the term “select”, when used with reference to some entity or value of an entity, is to be construed broadly as encompassing any manner of determining the entity or value of the entity from amongst a plurality or range of possible choices. For example, the term “select” is to be construed to encompass accessing and reading memory (e.g., lookup table, register, device memory, remote memory, and so on) that stores the entities or values for the entity and returning one entity or entity value from amongst those stored. The term “select” is to be construed as applying one or more constraints or rules to an input set of parameters to determine an appropriate entity or entity value. The term “select” is to be construed as broadly encompassing any manner of choosing an entity based on one or more parameters or conditions.

As used herein, the term “derive”, when used with reference to some entity or value of an entity, is to be construed broadly. “Derive” should be construed to encompass accessing and reading memory (e.g., lookup table, register, device memory, remote memory, and so on) that stores some initial value or foundational values and performing processing and/or logical/mathematical operations on the value or values to generate the derived entity or value for the entity. The term “derive” should be construed to encompass computing or calculating the entity or value of the entity based on other quantities or entities. The term “derive” should be construed to encompass any manner of deducing or identifying an entity or value of the entity.

As used herein, the term “indicate”, when used with reference to some entity (e.g., parameter or setting) or value of an entity, is to be construed broadly as encompassing any manner of communicating the entity or value of the entity, either explicitly or implicitly. For example, bits within a transmitted message may be used to explicitly encode an indicated value or may encode an index or other indicator that is mapped to the indicated value by prior configuration. The absence of a field within a message may implicitly indicate a value of an entity based on prior configuration.

### EXAMPLES

Example 1 is an apparatus for a user equipment (UE), including a memory and a processor, the processor coupled to the memory and configured to, when executing instructions stored in the memory, cause the UE to: determine, via a cellular network, an entitlement of the UE to a service of a broadband network; generate a token for the service; create a blind token based on the token; transmit, via the cellular network to a server, the blind token for signing; receive, via the cellular network from the server, a blind signature for the blind token; unblind the blind signature to yield an unblinded signature; and store the unblinded signature and the token for subsequent access to the service.

Example 2 includes the subject matter of Example 1, including or omitting optional elements, wherein the unblinded signature and the token are stored in the UE.

Example 3 includes the subject matter of Example 1, including or omitting optional elements, wherein the unblinded signature and the token are stored in a data storage that is accessible via at least one of the cellular network or the broadband network.

Example 4 includes the subject matter of Example 1, including or omitting optional elements, wherein the service includes a quality-of-service (QOS)-related service.

Example 5 includes the subject matter of Example 4, including or omitting optional elements, wherein the QoS-related service includes an enhanced throughput service.

Example 6 includes the subject matter of Example 4, including or omitting optional elements, wherein the QoS-related service includes a reduced latency service.

Example 7 includes the subject matter of Example 1, including or omitting optional elements, wherein the service includes a parental control service.

Example 8 includes the subject matter of Example 1, including or omitting optional elements, wherein the service includes one or more services configured for a corresponding device type.

Example 9 includes the subject matter of Example 1, including or omitting optional elements, wherein the token includes an identifier for the service.

Example 10 includes the subject matter of Example 1, including or omitting optional elements, wherein the processor is further configured to cause the UE to: retrieve, from a data storage via the cellular network, a device identifier for a device associated with the UE, wherein the token includes the device identifier.

Example 11 includes the subject matter of Example 1, including or omitting optional elements, wherein creating the blind token includes encrypting the token using a public key of the server.

Example 12 includes the subject matter of Example 11, including or omitting optional elements, wherein the blind signature includes an encryption of the blind token by a private key of the server.

Example 13 includes the subject matter of Example 12, including or omitting optional elements, wherein unblinding the blind signature includes decrypting the blind signature using the public key of the server.

Example 14 includes the subject matter of Example 1, including or omitting optional elements, wherein the processor is further configured to cause the UE to: store a provisioning domain identifier associated with the UE.

Example 15 includes the subject matter of Example 1, including or omitting optional elements, wherein the processor is configured to cause the UE to: transmit, to a server via the broadband network, the token and the unblinded signature; and receive, from the server via the broadband network, based on the token and the unblinded signature, an indication whether the UE is enabled for the service.

Example 16 is an apparatus for a device connectible to a broadband network, the apparatus including a memory and a processor, the processor coupled to the memory and configured to, when executing instructions stored in the memory, cause the device to: receive, from a data storage, a token and an unblinded signature associated with the token, the token indicating an entitlement of a user equipment (UE) associated with the device to a service of the broadband network; transmit, to a server via the broadband network, the token and the unblinded signature; and receive, from the server via the broadband network, based on the token and the unblinded signature, an indication whether the device is enabled for the service.

Example 17 includes the subject matter of Example 16, including or omitting optional elements, wherein the data storage is located in the UE.

Example 18 includes the subject matter of Example 16, including or omitting optional elements, wherein the data storage is accessible via the broadband network.

Example 19 includes the subject matter of Example 16, including or omitting optional elements, wherein the processor is further configured to cause the device to: transmit, to the data storage, a request for the token and the unblinded signature, the request including a device identifier for the device.

Example 20 includes the subject matter of Example 16, including or omitting optional elements, wherein the processor is further configured to cause the device to: receive, from a wireless router coupling the device to the broadband network, a first provisioning domain identifier; and receive, from the data storage, a second provisioning domain identifier; wherein the token and the unblinded signature are transmitted to the server in response to the first provisioning domain identifier being equal to the second provisioning domain identifier.

Example 21 includes the subject matter of Example 16, including or omitting optional elements, wherein the processor is further configured to cause the device to: determine, via the broadband network, an indication of an availability of the service of the broadband network.

Example 22 includes the subject matter of Example 16, including or omitting optional elements, wherein transmitting the token and the unblinded signature further includes transmitting a device identifier for the device and an Internet Protocol (IP) address for the device.

Example 23 is an apparatus for a server, the apparatus including a memory and a processor, the processor coupled to the memory and configured to, when executing instructions stored in the memory, cause the server to: receive, via a cellular network from a user equipment (UE), an enquiry whether the UE has an entitlement to a service of a broadband network; transmit, via the cellular network to the UE, a response to the enquiry, the response indicating the UE has the entitlement to the service; receive, via the cellular network from the UE, a blind token, the blind token based on a token for the entitlement; and transmit, via the cellular network to the UE, a blind signature for the blind token.

Example 24 includes the subject matter of Example 23, including or omitting optional elements, wherein the token includes a device identifier for a device associated with the UE

Example 25 includes the subject matter of Example 23, including or omitting optional elements, wherein the processor is further configured to cause the server to: encrypt the blind token using a private key of the server.

Example 26 includes the subject matter of Example 23, including or omitting optional elements, wherein the processor is further configured to cause the server to: receive, via the broadband network from the UE, the token, an unblinded signature based on the blind signature, and at least one of an Internet Protocol (IP) address or a random Media Access Control (MAC) address for the UE; validate the token and the unblinded signature; and transmit, to another server, a first indication that the service is enabled for the UE and the at least one of the IP address or the random MAC address.

Example 27 includes the subject matter of Example 26, including or omitting optional elements, wherein the processor is further configured to cause the server to: transmit, to the UE via the broadband network using the at least one of the IP address or the random MAC address, a second indication that the service is enabled for the UE.

Example 28 includes the subject matter of Example 23, including or omitting optional elements, wherein the processor is further configured to cause the server to: receive, via the broadband network from a device associated with the UE, the token, an unblinded signature based on the blind signature, and at least one of an Internet Protocol (IP) address or a random Media Access Control (MAC) address for the device; validate the token and the unblinded signature; and transmit, to another server, a first indication that the service is enabled for the device and the at least one of the IP address or the random MAC address.

Example 29 includes the subject matter of Example 28, including or omitting optional elements, wherein the processor is further configured to cause the server to: transmit, to the device via the broadband network using the at least one of the IP address or the random MAC address, a second indication that the service is enabled for the device.

Example 30 is a method for a user equipment (UE), the method including: determining, via a cellular network, an entitlement of the UE to a service of a broadband network; generating a token for the service; creating a blind token based on the token; transmitting, via the cellular network to a server, the blind token for signing; receiving, via the cellular network from the server, a blind signature for the blind token; unblinding the blind signature to yield an unblinded signature; and storing the unblinded signature and the token for subsequent access to the service.

Example 31 includes the subject matter of Example 30, including or omitting optional elements, the method further including: transmitting, to a server via the broadband network, the token and the unblinded signature; and receiving, from the server via the broadband network, based on the token and the unblinded signature, an indication whether the UE is enabled for the service.

Example 32 is a method for a device connectible to a broadband network, the method including: receiving, from a data storage, a token and an unblinded signature associated with the token, the token indicating an entitlement of a user equipment (UE) associated with the device to a service of the broadband network; transmitting, to a server via the broadband network, the token and the unblinded signature; and receiving, from the server via the broadband network, based on the token and the unblinded signature, an indication whether the device is enabled for the service.

Example 33 is a method for a server of a broadband network, the method including: receiving, via a cellular network from a user equipment (UE), an enquiry whether the UE has an entitlement to a service of the broadband network; transmitting, via the cellular network to the UE, a response to the enquiry, the response indicating the UE has the entitlement to the service; receiving, via the cellular network from the UE, a blind token, the blind token based on a token for the entitlement; and transmitting, via the cellular network to the UE, a blind signature for the blind token.

Example 34 includes the subject matter of Example 33, including or omitting optional elements, the method further including: receiving, via the broadband network from the UE, the token, an unblinded signature based on the blind signature, and at least one of an Internet Protocol (IP) address or a random Media Access Control (MAC) address for the UE; validating the token and the unblinded signature; and transmitting, to another server, a first indication that the service is enabled for the UE and the at least one of the IP address or the random MAC address.

Example 35 includes the subject matter of Example 33, including or omitting optional elements, the method further including: receiving, via the broadband network from a device associated with the UE, the token, an unblinded signature based on the blind signature, and at least one of an Internet Protocol (IP) address or a random Media Access Control (MAC) address for the device; validating the token and the unblinded signature; and transmitting, to another server, a first indication that the service is enabled for the device and the at least one of the IP address or the random MAC address.

Example 36 is a computer program product including program instructions which, when executed by a computer, cause an implementation of the subject matter of either of Examples 30 or 31, including or omitting optional elements.

Example 37 is a computer program product including program instructions which, when executed by a computer, cause an implementation of the subject matter of Example 32, including or omitting optional elements.

Example 38 is a computer program product including program instructions which, when executed by a computer, cause an implementation of the subject matter of any of Examples 33-35, including or omitting optional elements.

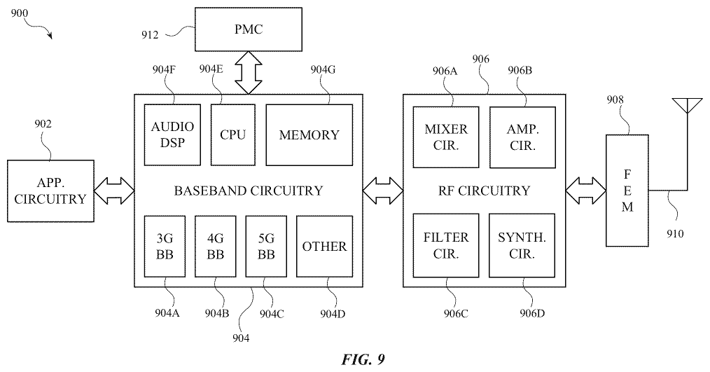

FIG. 9 is a diagram of an example of components of a wireless communication device 900 according to one or more implementations described herein. In some implementations, the device 900 can include application circuitry 902, baseband circuitry 904, RF circuitry 906, front-end module (FEM) circuitry 908, one or more antennas 910, and power management circuitry (PMC) 912 coupled together at least as shown. The components of the illustrated device 900 can be included in a UE or a RAN node. In some implementations, the device 900 can include fewer elements (e.g., a RAN node may not utilize application circuitry 902, and instead include a processor/controller to process IP data received from a CN or an Evolved Packet Core (EPC)). In some implementations, the device 900 can include additional elements such as, for example, memory/storage, display, camera, sensor (including one or more temperature sensors, such as a single temperature sensor, a plurality of temperature sensors at different locations in device 900, etc.), or input/output (I/O) interface. In other implementations, the components described below can be included in more than one device (e.g., said circuitries can be separately included in more than one device for Cloud-RAN (C-RAN) implementations).

The application circuitry 902 can include one or more application processors. For example, the application circuitry 902 can include circuitry such as, but not limited to, one or more single-core or multi-core processors. The processor(s) can include any combination of general-purpose processors and dedicated processors (e.g., graphics processors, application processors, etc.). The processors can be coupled with or can include memory/storage and can be configured to execute instructions stored in the memory/storage to enable various applications or operating systems to run on the device 900. In some implementations, processors of application circuitry 902 can process IP data packets received from an EPC.

The baseband circuitry 904 can include circuitry such as, but not limited to, one or more single-core or multi-core processors. The baseband circuitry 904 can include one or more baseband processors or control logic to process baseband signals received from a receive signal path of the RF circuitry 906 and to generate baseband signals for a transmit signal path of the RF circuitry 906. Baseband circuitry 904 can interface with the application circuitry 902 for generation and processing of the baseband signals and for controlling operations of the RF circuitry 906. For example, in some implementations, the baseband circuitry 904 can include a 3G baseband processor 904A, a 4G baseband processor 904B, a 5G baseband processor 904C, or other baseband processor(s) 904D for other existing generations, generations in development or to be developed in the future (e.g., 5G, 6G, etc.).

The baseband circuitry 904 (e.g., one or more of baseband processors 904A-D) can handle various radio control functions that enable communication with one or more radio networks via the RF circuitry 906. In other implementations, some or all of the functionality of baseband processors 904A-D can be included in modules (e.g., sets of executable instructions) stored in the memory 904G or other machine-readable or computer-readable medium (e.g., a non-transitory machine-readable or computer-readable storage medium) and executed via a Central Processing Unit (CPU) 904E or another type of processor (e.g., a reduced instruction set computing (RISC) processor, a complex instruction set computing (CISC) processor, a graphics processing unit (GPU), a digital signal processor (DSP) such as a baseband processor, an application-specific integrated circuit (ASIC), a radio-frequency integrated circuit (RFIC), another processor, or any suitable combination thereof).

The radio control functions can include, but are not limited to, signal modulation/demodulation, encoding/decoding, radio frequency shifting, etc. In some implementations, modulation/demodulation circuitry of the baseband circuitry 904 can include Fast-Fourier Transform (FFT), precoding, or constellation mapping/de-mapping functionality. In some implementations, encoding/decoding circuitry of the baseband circuitry 904 can include convolution, tail-biting convolution, turbo, Viterbi, or Low-Density Parity Check (LDPC) encoder/decoder functionality. Implementations of modulation/demodulation and encoder/decoder functionality are not limited to these examples and can include other suitable functionality in other implementations.

In some implementations, the baseband circuitry 904 can include one or more audio digital signal processor(s) (DSP) 904F. The audio DSPs 904F can include elements for compression/decompression and echo cancellation and can include other suitable processing elements in other implementations. Components of the baseband circuitry 904 can be suitably combined in a single chip, a single chipset, or disposed on a same circuit board in some implementations. In some implementations, some or all of the constituent components of the baseband circuitry 904 and the application circuitry 902 can be implemented together such as, for example, on a system-on-a-chip (SOC).

In some implementations, the baseband circuitry 904 can provide for communication compatible with one or more radio technologies. For example, in some implementations, the baseband circuitry 904 can support communication with an NG-RAN, an E-UTRAN or other wireless metropolitan area networks (WMAN), a wireless local area network (WLAN), a wireless personal area network (WPAN), etc. Implementations in which the baseband circuitry 904 is configured to support radio communications of more than one wireless protocol can be referred to as multi-mode baseband circuitry.

RF circuitry 906 can embody an RF transceiver that enables communication with wireless networks using modulated electromagnetic radiation through a non-solid medium. In various implementations, the RF circuitry 906 can include switches, filters, amplifiers, etc. to facilitate the communication with the wireless network. RF circuitry 906 can include a receive signal path which can include circuitry to down-convert RF signals received from the FEM circuitry 908 and provide baseband signals to the baseband circuitry 904. RF circuitry 906 can also include a transmit signal path which can include circuitry to up-convert baseband signals provided by the baseband circuitry 904 and provide RF output signals to the FEM circuitry 908 for transmission.

In some implementations, the receive signal path of the RF circuitry 906 can include mixer circuitry 906A, amplifier circuitry 906B, and filter circuitry 906C. RF circuitry 906 can also include synthesizer circuitry 906D for synthesizing a frequency for use by the mixer circuitry 906A of the receive signal path and the transmit signal path.

The RF circuitry 906 can include analog-to-digital converter (ADC) and digital-to-analog converter (DAC) circuitry, and the baseband circuitry 904 can include a digital baseband interface to communicate with the RF circuitry 906.

Synthesizer circuitry 906D of the RF circuitry 906 can include a divider, a delay-locked loop (DLL), a multiplexer, and a phase accumulator.

FEM circuitry 908 can include a receive signal path which can include circuitry configured to operate on RF signals received from one or more antennas 910, amplify the received signals, and provide the amplified versions of the received signals to the RF circuitry 906 for further processing. FEM circuitry 908 can also include a transmit signal path which can include circuitry configured to amplify signals for transmission provided by the RF circuitry 906 for transmission by one or more of the one or more antennas 910. In various implementations, the amplification through the transmit and/or receive signal paths can be done solely in the RF circuitry 906, solely in the FEM circuitry 908, or in both the RF circuitry 906 and the FEM circuitry 908.

In some implementations, the FEM circuitry 908 can include a TX/RX switch to switch between transmit mode and receive mode operation. The FEM circuitry can include a receive signal path and a transmit signal path. The receive signal path of the FEM circuitry can include an LNA to amplify received RF signals and provide the amplified received RF signals as an output (e.g., to the RF circuitry 906). The transmit signal path of the FEM circuitry 908 can include a power amplifier (PA) to amplify input RF signals (e.g., provided by RF circuitry 906), and one or more filters to generate RF signals for subsequent transmission (e.g., by one or more of the one or more antennas 910).

Processors of the application circuitry 902 and processors of the baseband circuitry 904 can be used to execute elements of one or more instances of a protocol stack. For example, processors of the baseband circuitry 904, alone or in combination, can be used to execute Layer 3, Layer 2, or Layer 1 functionality, while processors of the baseband circuitry 904 can utilize data (e.g., packet data) received from these layers and further execute Layer 4 functionality (e.g., transmission communication protocol (TCP) and user datagram protocol (UDP) layers). As referred to herein, Layer 3 can include a radio resource control (RRC) layer, described in further detail below. As referred to herein, Layer 2 can include a medium access control (MAC) layer, a radio link control (RLC) layer, and a PDCP layer, described in further detail below. As referred to herein, Layer 1 can include a physical (PHY) layer of a UE/RAN node.

In some implementations, the PMC 912 can manage power provided to the baseband circuitry 904. In particular, the PMC 912 can control power-source selection, voltage scaling, battery charging, or DC-to-DC conversion. The PMC 912 can often be included when the device 900 is capable of being powered by a battery, for example, when the device is included in a UE. The PMC 912 can increase the power conversion efficiency while providing desirable implementation size and heat dissipation characteristics.

While FIG. 9 shows the PMC 912 coupled only with the baseband circuitry 904, in other implementations, the PMC 912 may be additionally or alternatively coupled with, and perform similar power management operations for, other components such as, but not limited to, application circuitry 902, RF circuitry 906, or FEM circuitry 908.

In some implementations, the PMC 912 can control, or otherwise be part of, various power saving mechanisms of the device 900. For example, if the device 900 is in an RRC_CONNECTED state, where it is still connected to the RAN node as it expects to receive traffic shortly, then it can enter a state known as Discontinuous Reception (DRX) mode after a period of inactivity. During this state, the device 900 can power down for brief intervals of time and thus save power.

If there is no data traffic activity for an extended period of time, then the device 900 can transition off to an RRC_IDLE state, where it disconnects from the network and does not perform operations such as channel quality feedback, handover, etc. The device 900 goes into a very low power state and it performs paging where again it periodically wakes up to listen to the network and then powers down again. The device 900 may not receive data in this state; in order to receive data, it can transition back to the RRC_CONNECTED state.

The baseband circuitry 904, or the one or more baseband processors or control logic of the baseband circuitry 904, may stand alone as the UE 110 and/or device 112 of FIG. 1 to perform signaling and operation in the meaning as described throughout this disclosure.

Examples herein can include subject matter such as a method, means for performing acts or blocks of the method, at least one machine-readable medium including executable instructions that, when performed by a machine (e.g., a processor with memory, an application-specific integrated circuit (ASIC), a field-programmable gate array (FPGA), or the like) cause the machine to perform acts of the method or of an apparatus or system for concurrent communication using multiple communication technologies according to implementations and examples described.

In this regard, while the disclosed subject matter has been described in connection with various examples, implementations, aspects, etc., and corresponding Figures, where applicable, it is to be understood that other similar aspects can be used or modifications and additions can be made to the disclosed subject matter for performing the same, similar, alternative, or substitute function of the subject matter without deviating therefrom. Therefore, the disclosed subject matter should not be limited to any single example, implementation, or aspect described herein, but rather should be construed in breadth and scope in accordance with the appended claims below.

In particular regard to the various functions performed by the above-described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations. In addition, while a particular feature may have been disclosed with respect to only one of several implementations, such feature may be combined with one or more other features of the other implementations as may be desired and advantageous for any given application.

As used herein, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description or the claims, such terms are intended to be inclusive in a manner similar to the term “comprising.” Additionally, in situations wherein one or more numbered items are discussed (e.g., a “first X”, a “second X”, etc.), in general the one or more numbered items can be distinct, or they can be the same, although in some situations the context may indicate that they are distinct or that they are the same.

It is well understood that the use of personally identifiable information should follow privacy policies and practices that are generally recognized as meeting or exceeding industry or governmental requirements for maintaining the privacy of users. In particular, personally identifiable information data should be managed and handled to minimize risks of unintentional or unauthorized access or use, and the nature of authorized use should be clearly indicated to users.

What is claimed is:

1. A user equipment (UE), comprising:
a memory; and
a processor coupled to the memory and configured to, when executing instructions stored in the memory, cause the UE to:
determine, via a cellular network, an entitlement of the UE to a service of a broadband network;
generate a token for the service;
create a blind token based on the token;
transmit, via the cellular network to a server, the blind token for signing;
receive, via the cellular network from the server, a blind signature for the blind token;
unblind the blind signature to yield an unblinded signature; and
store the unblinded signature and the token for subsequent access to the service.

2. The UE of claim 1, wherein the token comprises an identifier for the service.

3. The UE of claim 1, wherein the processor is further configured to cause the UE to:
retrieve, from a data storage via the cellular network, a device identifier for a device associated with the UE, wherein the token comprises the device identifier.

4. The UE of claim 1, wherein creating the blind token comprises encrypting the token using a public key of the server.

5. The UE of claim 4, wherein the blind signature comprises an encryption of the blind token by a private key of the server.

6. The UE of claim 5, wherein unblinding the blind signature comprises decrypting the blind signature using the public key of the server.

7. The UE of claim 1, wherein the processor is further configured to cause the UE to:
store a provisioning domain identifier associated with the UE.

8. The UE of claim 1, wherein the processor is further configured to cause the UE to:
transmit, to the server via the broadband network, the token and the unblinded signature; and
receive, from the server via the broadband network, based on the token and the unblinded signature, an indication whether the UE is enabled for the service.

9. A device connectible to a broadband network, the device comprising:
a memory; and
a processor coupled to the memory and configured to, when executing instructions stored in the memory, cause the device to:
receive, from a data storage, a token and an unblinded signature associated with the token, the token indicating an entitlement of a user equipment (UE) associated with the device to a service of the broadband network;
transmit, to a server via the broadband network, the token and the unblinded signature; and
receive, from the server via the broadband network, based on the token and the unblinded signature, an indication whether the device is enabled for the service.

10. The device of claim 9, wherein the processor is further configured to cause the device to:
transmit, to the data storage, a request for the token and the unblinded signature, the request including a device identifier for the device.

11. The device of claim 9, wherein the processor is further configured to cause the device to:
receive, from a wireless router coupling the device to the broadband network, a first provisioning domain identifier; and
receive, from the data storage, a second provisioning domain identifier;
wherein the token and the unblinded signature are transmitted to the server in response to the first provisioning domain identifier being equal to the second provisioning domain identifier.

12. The device of claim 9, wherein the processor is further configured to cause the device to:
determine, via the broadband network, an indication of an availability of the service of the broadband network.

13. The device of claim 9, wherein transmitting the token and the unblinded signature further comprises transmitting a device identifier for the device and an Internet Protocol (IP) address for the device.

14. A server, comprising:
a memory; and
a processor coupled to the memory and configured to, when executing instructions stored in the memory, cause the server to:
receive, via a cellular network from a user equipment (UE), an enquiry whether the UE has an entitlement to a service of a broadband network;
transmit, via the cellular network to the UE, a response to the enquiry, the response indicating the UE has the entitlement to the service;
receive, via the cellular network from the UE, a blind token, the blind token based on a token for the entitlement; and
transmit, via the cellular network to the UE, a blind signature for the blind token.

15. The server of claim 14, wherein the token comprises a device identifier for a device associated with the UE.

16. The server of claim 14, wherein the processor is further configured to cause the server to:
encrypt the blind token using a private key of the server.

17. The server of claim 14, wherein the processor is further configured to cause the server to:
receive, via the broadband network from the UE, the token, an unblinded signature based on the blind signature, and at least one of an Internet Protocol (IP) address or a random Media Access Control (MAC) address for the UE;
validate the token and the unblinded signature; and
transmit, to another server, a first indication that the service is enabled for the UE and the at least one of the IP address or the random MAC address.

18. The server of claim 17, wherein the processor is further configured to cause the server to:
transmit, to the UE via the broadband network using the at least one of the IP address or the random MAC address, a second indication that the service is enabled for the UE.

19. The server of claim 14, wherein the processor is further configured to cause the server to:
receive, via the broadband network from a device associated with the UE, the token, an unblinded signature based on the blind signature, and at least one of an Internet Protocol (IP) address or a random Media Access Control (MAC) address for the device;
validate the token and the unblinded signature; and
transmit, to another server, a first indication that the service is enabled for the device and the at least one of the IP address or the random MAC address.

20. The server of claim 19, wherein the processor is further configured to cause the server to:
transmit, to the device via the broadband network using the IP address, a second indication that the service is enabled for the device.
